(19) United States
(12) Patent Application Publication
(10) Pub. No.: US 2003/0061033 A1
(43) Pub. Date: Mar. 27, 2003

(54) Remote control system for translating an utterance to a control parameter for use by an electronic device

(76) Inventor: Lee R. Dishert, Burlington, NJ (US)

Correspondence Address: RATNERPRESTIA, P O BOX 980, VALLEY FORGE, PA, 19482-0980, US

(21) Appl. No.: 09/963,324

(22) Filed: Sep. 26, 2001

(51) Int. Cl. G10L 21/00

(52) U.S. Cl. 704/201

(57) ABSTRACT

A remote control system is provided for translating an utterance of an operator to a control parameter of an electronic device. A remote control of the system includes an audio input for receiving the utterance. A transmitter of the remote control is operably linked to the audio input for providing a transmission signal corresponding to the utterance. A relay station is responsive to the transmission signal. The relay station includes a receiver for recovering the utterance from the transmission signal and a speech recognition module for translating the utterance of the operator into the control parameter. In this way, the control parameter is provided to an electronic device enabling hands-free remote control of the electronic device.

### BACKGROUND OF THE INVENTION

The present invention relates to a remote control system and, more particularly, to a speech recognition control system for translating an utterance of an operator to a control parameter of an electronic device.

Remote control units for operating electronic devices are well known. Operators of electronic devices utilize hand-held remote control units to operate the electronic devices and/or adjust their functionality from a remote location. For example, consumer electronic devices such as televisions, video recorders, audio systems, digital versatile disc (DVD) players and the like are typically controlled via hand-held remote control units. As remote control devices have become numerous and commonplace in day-to-day use, operators of consumer electronic devices have become increasingly dependent upon these devices to properly operate consumer electronic equipment.

Consumer entertainment systems often consist of several different electronic devices (i.e., television, video recorder, cable set-top box, etc), a corresponding hand-held remote control is typically provided to operate each device. Contemporary consumer electronic device design include few switches and/or hand controls located on the devices, instead hand-held remote control units are often relied upon for accessing more than the basic device functionality.

The functionality of consumer electronic devices has become increasingly complex in operation as devices include more features for processing digital television broadcasts and advanced audio features (e.g., Surround Sound, THX®, etc). As device complexity increases, the corresponding hand-held remote control unit likewise increases in complexity. As can be appreciated, hand-held remote control units are designed to be compact in size. As the number of switches increases, however, their layout (i.e., size/dimension of switches, grouping) must decrease.

While “universal” hand-held remote control units can be programmed to incorporate the functionality of several remote control units and their corresponding electronic device, in order to properly access most functions of the devices, the universal remote control unit typically provides a large number of tiny switches. The size of the switches and their relatively tight spacing with respect to each other, makes these remote control units particularly difficult to operate, especially for the elderly and infirm.

Accordingly, there is a need for a remote control unit which operates via speech recognition to translate an utterance of an operator to a control parameter of an electronic device for enabling “hands-free” operation.

### SUMMARY OF THE INVENTION

A remote control system in accordance with the present invention operates via speech recognition to translate an utterance of an operator to a control parameter for an electronic device enabling hands-free remote control of the electronic device.

The present invention provides a remote control system for translating an utterance of an operator to a control parameter of an electronic device. A remote control of the system includes an audio input port for receiving the utterance. A transmitter of the remote control is operably linked to the audio input port for providing a transmission signal corresponding to the utterance. A relay station is responsive to the transmission signal. The relay station includes a receiver for recovering the utterance from the transmission signal and a speech recognition module for translating the utterance of the operator into the control parameter. The control parameter is provided to an electronic device enabling hands-free remote control of the electronic device.

The present invention additionally provides a remote control unit having a receiver and an audio output for receiving a feedback communication from the electronic device for prompting the operator to select from one of a plurality of menu selections.

The present invention further provides a method of translating an utterance of an operator to a control parameter of an electronic device. An utterance is provided to an audio input of a remote control unit. The audio input is transmitted as a transmission signal corresponding to the utterance from the remote control unit. The transmission signal is received at a relay unit and the utterance is recovered from the transmission signal. The utterance is translated into a control parameter with a speech recognition module of the relay unit. Thus, the control parameter is provided to an electronic device enabling hands-free remote control of the electronic device

The present invention also provides a method of translating an utterance of an operator to a control parameter, and receiving a feedback signal from the electronic device in response to the control parameter for prompting the operator of the remote control system to select from a plurality of available control parameters. An utterance is provided to an audio input of a remote control unit. The audio input is transmitted as a transmission signal corresponding to the utterance from the remote control unit. The transmission signal is received at a relay unit and the utterance is recovered from the transmission signal. The utterance is translated into a control parameter with a speech recognition module of the relay unit. The control parameter is transmitted from the relay unit to the electronic device. A feedback signal is received from the electronic device at the relay unit. The feedback signal is transmitted from the relay unit to the remote control unit. The feedback signal is sent to an audio output of the remote control unit, whereby the feedback signal prompts an operator of the remote control unit to select one of a plurality of menu options of the electronic device. Alternatively, the menu may be displayed on a display device coupled to the electronic device and the relay unit may receive spoken commands to navigate and select menu options via the remote control unit. The user's selection is indicated on the displayed menu.

### BRIEF DESCRIPTION OF THE DRAWINGS

These and other features, aspects, and advantages of the present invention will become more fully apparent from the following description, appended claims, and accompanying drawings in which:

FIG. 1 is a plan view a remote control system for translating an utterance to a control parameter for use by an electronic device in accordance with an exemplary embodiment of the invention;

FIG. 2 is a high level block diagram of the remote control unit and relay station of the exemplary remote control system of FIG. 1;

FIG. 3 is a flow chart illustrating a method of operation of the remote control unit of FIG. 1 in accordance with an exemplary embodiment of the present invention; and

FIG. 4 is a flow chart illustrating a method of operation of the relay unit of FIG. 1 in accordance with an exemplary embodiment of the present invention.

### DESCRIPTION OF THE PREFERRED EMBODIMENT

Certain terminology used in the following description is for convenience only and is not limiting. The term “electronic device” is defined as referring to any electronic device which is capable of receiving a signal originated from an external source for controlling the operation of the device via a direct input or wireless input. In the drawings, the same reference numerals are used for designating the same elements throughout the several figures.

The present invention provides a remote control system for recognizing utterances of an operator of at least one electronic device. The system enables operators to operate the functions of at least one electronic device from a remote location by simply speaking into an audio input of the remote control unit of the system.

A remote control system in accordance with an exemplary embodiment of the invention translates an utterance of an operator into a control parameter for an electronic device. A remote control unit of the system includes an audio input for receiving the utterance. A transmitter of the remote control is operably linked to the audio input for providing a transmission signal corresponding to the utterance. A relay station is responsive to the transmission signal. The relay station includes a receiver for recovering the utterance from the transmission signal and a speech recognition module for translating the utterance of the operator into the control parameter. In this way, the control parameter is provided to an electronic device enabling hands-free remote control of the electronic device.

I. System Components

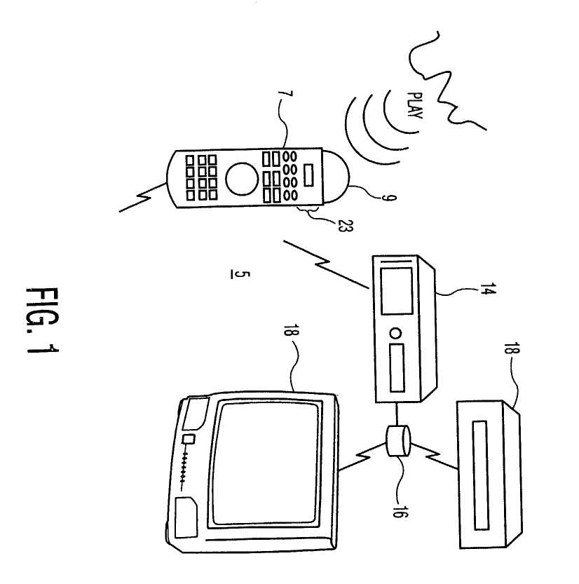

Referring now more specifically to the drawings, FIG. 1 shows a plan view of the remote control system 5 in accordance with the present invention. In the exemplary embodiment, the remote control system 5 includes a remote control unit 7, having an audio input (e.g. microphone) 9 for receiving utterances of an operator, transmission switch 23, a relay unit 14, a transmitter 16, and electronic devices 18. While the exemplary embodiment is described with reference to electronic devices which employ infrared signals for remote control operation, those skilled in the art will recognize that the present invention is applicable to a variety of wireless transmission technologies such as radio frequency (RF) technology or Blue Tooth®.

In the exemplary embodiment, the remote control unit 7 receives utterances of an operator via an omni-directional microphone 9 when transmission switch 23 is actuated. Transmission switch 23 is provided to ensure that transmissions are initiated only when desired (i.e., no transmission of ambient noise). The remote control unit 7 receives the utterances and provides a transmission signal corresponding to the utterances. In the exemplary embodiment, the transmission signal is an infrared signal modulated by a signal corresponding to the utterances and provided to relay unit 14. In the exemplary embodiment, the infrared signal is provided from an end of the remote control unit 7 opposing the audio input 9. In this way, an operator speaking into audio input 9 can aim the infrared transmission emanating from the opposing end toward an electronic device 18. The placement of the infrared transmitter is exemplary only; it may be placed in any position that provides good line-of-sight when the remote control is held comfortably. In an alternative embodiment a radio frequency (RF) signal may be utilized, removing any constraints on how the remote control device is held.

The relay unit 14 of the exemplary embodiment is responsive to the transmission signal of the remote control unit 7 to recover the utterance from the transmission signal. In the exemplary embodiment, the utterance may modulate a carrier signal to form the transmission signal. Of course, in alternative embodiments, the utterance may be transmitted directly to the relay unit 14 without the use of a carrier signal. The exemplary relay unit 14 includes a receiver 16 for receiving the transmission signal of remote control unit 7 and recovering the utterance therefrom and a speech recognition module (SRM) (described below) to translate the utterances in to control parameters. The relay unit also includes an optional transmitter 32 which transmits the command to the electronic device. The transmitter 32 is optional because the transmission of signals to the electronic device and reception of signals from the electronic device may be done by other means, for example, an IEEE 1394 bus. The transmitter 32 is shown as a sleeve surrounding the receiver 16. In this configuration signals provided by the transmitter 32 can be directed away from the receiver 16, reducing crosstalk between the transmitter 32 and the receiver 16.

The exemplary relay unit 14 is provided separately from remote control unit 7 to provide greater functionality. For example, rely unit 14 may utilize a large database for operating the SRM, as well as storing manufacturer information for use in identifying the transmissions of the remote control unit 7 as described herein.

Upon translating the utterances into control parameters, the control parameters may be converted to a transmission protocol for acceptance at a remote control input of a corresponding electronic device 18. In the exemplary embodiment, the relay unit 14 is external to an electronic device 18, however those skilled in the art will recognize that the relay unit 14 may be internal and dedicated to a specific electronic device 18. In such an embodiment, the remote control unit 7 may include a selection means such as a selector switch or the like for addressing one of a plurality of dedicated relay stations 14. A particular station may be selected by the transmitter inserting an address value for that station into the transmitted message. Similarly, although transmitter 32 and receiver 16 are shown external to relay unit 14 those skilled in the art will recognize that either one or both of receiver 16 and transmitter 32 may be internal to relay unit 14.

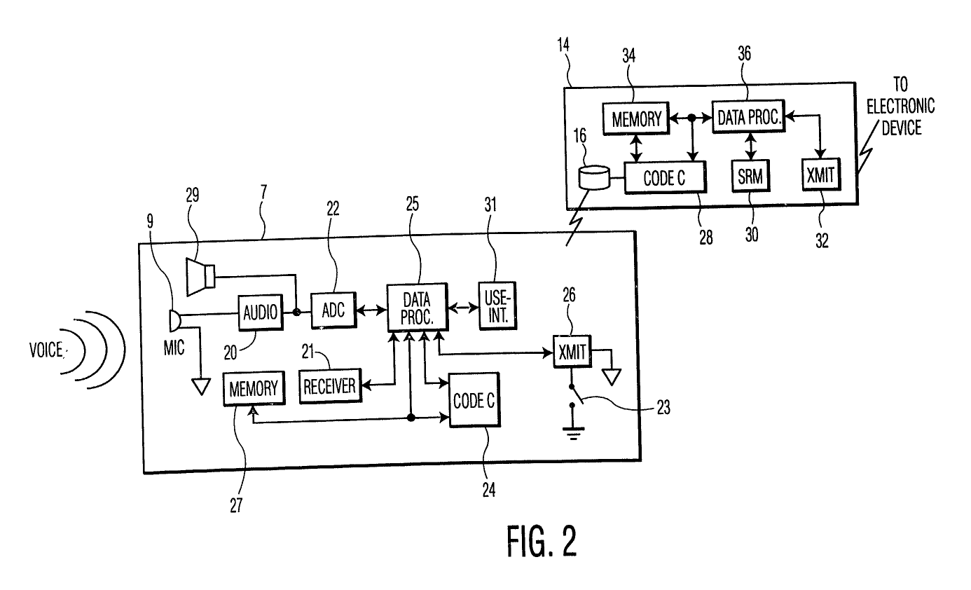

In an alternative embodiment, the electronic device 18 may provide a feedback signal to receiver 16 of relay unit or directly to optional receiver of remote control unit 7. The receiver 16 and transmitter 32 of relay unit 14 may be utilized where a greater transmission strength is desired to ensure good communication with remote control unit 7. This may be desirable when the remote control unit 7 is used at a substantial distance from an electronic device 18. It may also be desirable to send the feedback signal through the relay unit 14 to translate responses in multiple protocols into a single protocol that can be used by the remote control unit 7. In this way, as described below, a speaker (see FIG. 2) of the remote control unit 7 may provide an audible prompt to operator 2 for selecting one of a plurality of menu prompts.

II. Remote Control Unit

FIG. 2, shows a high level block diagram of an exemplary remote control unit 7. In the exemplary embodiment, remote control unit 7 includes audio input 9, audio input processing circuitry 20, analog to digital converter (ADC) 22 (optional), receiver 21 (optional), channel coder 24, (optional) memory 27, transmission switch 23, data processor 25 (optional), transmitter 26, speaker 29, and user interface 31.

In the exemplary embodiment, the remote control unit 7 is powered by a local power supply, such as a battery (not shown). Of course the remote control unit 7 may include a power cord adapter for operably linking the remote control unit 7 to a suitable power source. For example, the remote control unit 7 employing a power cord may be preferred for applications where the remote control unit should remain substantially stationary such as in a hotel and/or hospital room.

A user interface 31 may be a standard “key-pad” interface as known to those skilled in the art for manually transmitting control parameters from the remote control unit 7 directly to the electronic devices 18 or to the relay unit 14 where it is desirable to use the translation functions of the relay unit, as described below.

In the exemplary embodiment, the audio input 9 is a microphone. The microphone 9 may be an omni-directional microphone, or the audio input 9 may include a plurality of microphones positioned to detect utterances from a variety of locations when the transmission switch 23 is actuated. In an alternative embodiment, the audio input 9 may be a microphone mounted on a headset (not shown), such as those utilized by cellular phone users. The utterances provided to the microphone of the headset or other external transducer, such as a hand-held microphone, may be provided to the remote control unit 7 via an audio input terminal of the remote control unit 7 (also not shown).

The audio input processing circuitry 20 may include circuitry for such functions as known to those skilled as impedance matching, noise suppression, electrical isolation, wave shaping, amplification and the like (not shown). If for example, the utterances of audio input 9, the audio input processing circuitry 20 may include a compressor preamplifier to ensure that even relatively low-level sounds can be digitized by the analog-to-digital (A/D) converter 22.

Analog to digital converter (ADC) 22 is responsive to the utterances received at the audio input 9. The received utterances in analog form are provided to audio input processing circuitry 20, and digitized by the ADC 22. Those skilled in the art will recognize that the utterances may be transmitted from the remote control unit 7 in analog form in embodiments that do not utilize an ADC 22.

In an alternative embodiment, the optional memory 27 of the remote control unit 7 may store data transmitted to the remote control unit 7 via receiver 21 from relay station 14 while the transmission switch 23 is actuated so as not to allow “double-talk” or simultaneous audio output and audio input. Further, the memory 27 may store audible menu prompts for directing an operator 2, via speaker 29, to provide further utterances. The audible menu prompts may be stored digitally, and converted to analog signals via a digital to analog converter (DAC) (not shown). It is also contemplated that actuation of the transmission switch 23 may send a signal to the relay unit 14 or directly to the electronic device 18 to mute any sound signals provided by the devices 18 while the transmission switch is actuated in order to prevent double-talk.

The audio channel coder-decoder 24 compresses the digital audio signal so that it may be efficiently transmitted between the remote control unit 7 and relay station 14. The audio channel coder-decoder 24 may include any of a number of widely used audio codecs such as MPEG-I, level 3 (MP3) or RealAudio, or a vocoder. In embodiments where the utterances are not digitized, the utterances may be modulated into an IR or RF transmission carrier signal using frequency modulation or amplitude modulation as will be known to those skilled in the art.

In the exemplary embodiment of the invention, the data processor 25 of remote control unit 7 may exchange control information and data with: ADC 22, audio input processing circuitry 20, receiver 21, audio channel coder-decoder 24 and transmitter 26 as indicated by the solid lines. Specifically, the data processor 25 receives data from the receiver 21 for processing by audio channel coder-decoder 24. It also provides data to the transmitter 26 from the audio coder-decoder 24 when transmission switch 23 is actuated. The data processor 25 may also provide control signals to the ADC 22 to control the timing of the digitization of the analog utterances. Of course, the data processor 25 may include a “scratch-pad” memory (not shown) for caching data, performing mathematical computations and the like and a program memory (not shown) for holding software instructions.

In the exemplary embodiment, transmitter 26 of remote control unit 7 may be an infrared transmission source or an RF transmission source, however the present invention is not limited to any specific carrier type/frequency. For example, in an alternative embodiment, an infrared transmitter 26 provides data between relay unit 14 and remote control unit 7. The transmitter 26 receives the output signal of the audio channel coder-decoder 24 for transmission as an input signal to the relay station 14.

In an alternative embodiment, the optional receiver 21 is provided for receiving transmissions, for example, from relay unit 14 to provide bi-directional communication and to provide prompts to the operator through speaker 29 which may be used to implement a menu selection interface. The memory 27 may include prerecorded utterances corresponding to a feedback signal received from relay station 14 for output to speaker 29 of remote control unit 7. In addition, the operator may utilize the microphone of audio input 9 and speaker 29 of the remote control unit 7 to conduct a telephone conversation by way of relay unit 14. In this embodiment, the feedback signal transmitted from relay station 14 would be voice communication, the relay unit 14 would include a telephone transceiver (not shown) as known to those skilled in the art. The receiver 21 and transmitter 23 of the relay station 14 may be separate components as shown or may be a combination transmitter and receiver (transceiver) for communicating with the relay station 14. When operating in telephone mode, the transmission switch 23 would not be used; all sound signals received by the microphone are sent to the relay station 14.

When operated as a remote control device, switch 23 is actuated to enable the transmitter 26 to transmit the utterances from remote control unit 7. Switch 23 may be any known switching technology for initiating a transmission. For example, a capacitive switch may be implemented such that the capacitive switch is activated upon an operator simply holding the remote control unit (i.e., varying the capacitance of the capacitive switch 23). Similarly, the switch 23 may be a voice level activated switch activated by sound levels above a predetermined threshold. Or, the switch 23 may be a motion detector/position switch triggered by movement of the remote control unit 7.

III. Relay Station.

Referring once again to FIG. 2, an exemplary relay station 14 is shown. The exemplary relay station 14 may include, for example, a receiver 16, a data processor 36, a memory 34 an audio channel coder-decoder 28, speech recognition module (SRM) 30 and transmitter 32.

In the exemplary embodiment of the invention, the data processor 36 communicates control information with the memory 34, receiver 16, SRM 30, codec 28 and transmitter 32 as indicated by the solid lines. Specifically, the data processor 36 provides control data to receiver 16, transmitter 32, memory 34 and audio channel coder-decoder 28. The data processor 36 may determine, for example, when to initiate periodic communication (i.e., scheduling of transmission/reception) in accordance with an instruction set. When the voice signals are received in analog form, the data processor 36 may also provide control signals to a digital to analog converter (DAC) (not shown) to control the timing of the digitization of the analog utterances. The data processor 36 may also include a “scratch-pad” memory for caching data, performing mathematical computations and the like, and a program memory for holding computer program instructions.

The SRM module 30 of the exemplary embodiment is responsive to an input audio signal of the audio channel coder-decoder 28 to dynamically convert the recovered utterances into recognized control parameters. The audio channel coder-decoder 28 provides utterances to an input port of the SRM module 30 for processing. The SRM module 30 may, for example, perform signal filtering to identify audio segments including speech components and to separate the speech segments from the audio input. The SRM module 30 may then process the speech signals through filters to identify various components which are applied to speech models, such as hidden Markov models, to convert the audio input into “phonemes” or speech parts. The phonemes are sent to a word matcher, which selects a matching word from a word database stored in memory 34 based on the identified phonemes of each word. The selected database word is then provided by the SRM 30 for conversion to a control parameter by data processor 36. The exemplary word database includes a context module that distinguishes between homophones such as “to,” “too” and “two.” An exemplary SRM suitable for use with the present invention is described in U.S. Pat. No. 5,822,728 entitled MULTISTAGE WORD RECOGNIZER BASED ON RELIABLY DETECTED PHONEME SIMILARITY REGIONS.

The exemplary SRM may also include a look-up table for converting specific spoken comments into IR signals for the selected electronic device 18. A protocol may be utilized for indicating which table is to be used from among a plurality of tables and/or table sections. For example, the first utterance of a string may be a table and/or section identifier and the second utterance may be a command. For example, consider the utterances, “VCR . . . FAST-FORWARD” or “TELEVISION . . . INPUT ANTENNA.” In the first of these examples, the spoken phrase “VCR” is recognized and causes the relay station to select the table of control words for the VCR. This table may be designated, for example, during set up procedures performed on the relay station. The next phrase “FAST FORWARD” is recognized and causes the relay station 74 to transmit the fast-forward control command from the selected menu. The second example works the same way, selecting the command list for the television receiver and then transmitting a command, from the list, to switch the RF input to receive signals from the antenna.

In the exemplary embodiment, a portion of the memory 34 may be arranged as a circular buffer to allow control parameters to be stored continuously, with the newer content overwriting the older content. In this way, control parameters producing a feedback signal can remain in memory for use in identifying the appropriate response signal from the remote control unit. Although the memory 34 is described as being a non-volatile memory, those skilled in the art will recognize that volatile memory devices such as a battery-backed DRAM may also be used. The primary function of the memory 34 is to store the operational data of the SRM 30. In the exemplary embodiment, a portion of memory 34 is reserved for use by the data processor 14 to enable bidirectional communication (i.e., look-up table of electronic devices and menu control parameters), and audio processing functionality. For example, where a control parameter is provided to an electronic device 18, the relay unit may recognize the control parameter transmitted to an electronic device 18 as requiring feedback from the electronic device 18. Thus, the receiver 16 will await transmission from an electronic device 18.

The receiver 16 and transmitter 32 of the relay station 14 may be separate components as shown or may be a combination transmitter and receiver (transceiver) for communicating with the remote control unit 7 (not shown). For example, in the exemplary embodiment, an infrared transmitter 32 and/or receiver 16 provides data communication between remote control unit 7 and relay unit 14. The transmitter 32 also receives the output signal of the SRM 30 as dictated by data processor 36 for transmission as an input signal to an electronic device 18 or to the receiver 21 of remote control unit 7.

The receiver 16 is provided for receiving transmissions from remote control unit 7. In an alternative embodiment, the receiver 16 may receive a feedback signal from an electronic device 18 to provide bi-directional communication between the electronic device 18 and the remote control unit 7, for example, via an IEEE 1394 (Firewire) interface. The feedback signal may be transmitted from transmitter 32 of relay station 14 for reception by receiver 21 of remote control unit 7 for output to speaker 29.

IV. Communication Methods

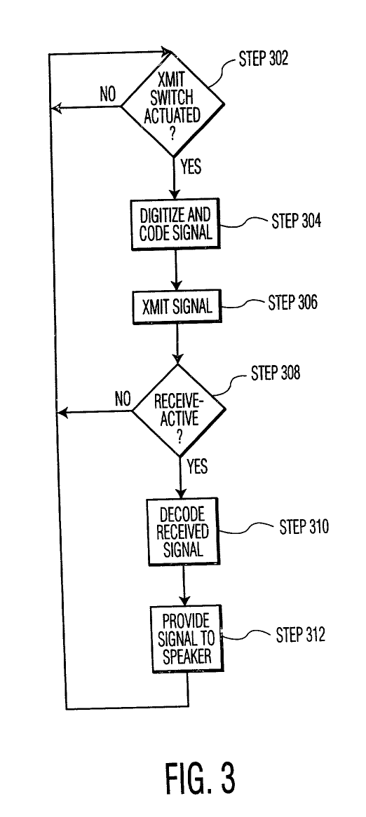

Referring now to FIG. 3, a flow chart illustrating a method of operation of the remote control unit 7 is shown in accordance with an exemplary embodiment of the present invention.

At step 302, the state of transmission switch 23 is detected. If the transmission switch 23 is not active, the process loops. If the switch is actuated (i.e., closed), then, at step 304, the audio input (i.e., utterance) present at microphone 9 is processed by audio input processing circuitry 20, digitized by ADC 22 (where desired) and coded by audio channel coder-decoder 24 into a transmission signal. At step 306 the transmission signal is transmitted by transmitter 23 to the receiver 16 of relay unit 14.

In an alternative embodiment, the process continues to step 308 and awaits a feedback signal via receiver 21. Where no feedback signal is available, after a predetermined delay, the process returns to step 302. At step 310, the feedback signal received by receiver 21 is decoded (where necessary). At step 312 the feedback signal is provided to the speaker 29 as a an audible prompt for selecting between a plurality of available menu options.

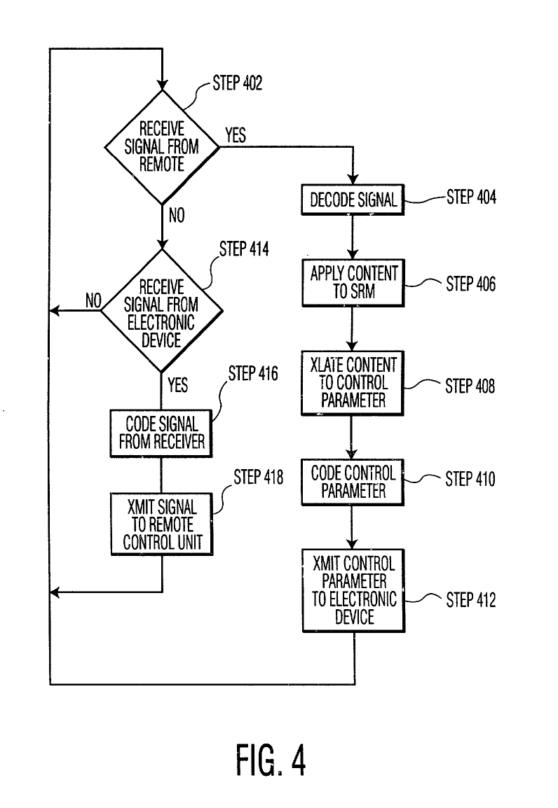

FIG. 4 is a flow chart diagram that shows a method of operation of the relay unit 14 in accordance with an exemplary embodiment of the present invention.

At step 402, the receiver 16 is monitored for a transmission, if no transmission signal is sensed by the receiver 16, the process continues to step 414. At step 414 the receiver may also monitor for reception of a feedback signal from an electronic device 18 or relay unit 14. At step 416, the feedback signal is coded (where desired) for transmission to remote control unit 7. At step 418, the transmission signal is transmitted from transmitter 32 to the remote control unit 7.

Upon detection of a transmission at step 402, the transmission signal is decoded at step 404 to recover the utterance. At step 406, the recovered utterances are input to SRM 30. At step 408 the utterances are translated into an identified control parameter for a specific electronic device 18. At step 410 the control parameter is coded. As described above, the coding may be specific to the identified electronic device 18. At step 412 the control parameter is transmitted to the electronic device 18, the process then loops back to step 402.

For example, an operator speaks into microphone 9 “VCR . . . AUDIO” the utterance is signal conditioned, coded and transmitted from remote control unit 7. The relay unit 14 receives the transmission signal at receiver 16 and decodes it. The utterance is then applied to SRM 30 to identify a corresponding electronic device 18 and/or control parameter in memory 34, which is then transmitted to the electronic device 18. The control parameters may be pre-programmed in the memory 34 upon manufacture, as is commonly done for conventional universal remote control devices, or may be programmed into memory 34 by the operator.

In response to a command corresponding to a selection menu, such as “VCR . . . AUDIO,” The control parameter may be provided to the VCR causing it to display a menu on the display screen of a television receiver that is coupled to the VCR. The viewer may make an audio selection, for example by saying the word “STEREO” after viewing this menu. The selection is then translated by the remote control unit 7 and relay unit 14 into a command parameter for the VCR, as described above, to select the stereo audio mode. In response to this command parameter, the exemplary VCR may implement the command or it may highlight the “STEREO” selection of the menu to indicate to the user that the command has been received. The menu may then prompt the user to verify the selection, for example by displaying the text “to accept menu choice say “ENTER” to make another selection say “BACK.” Alternatively, the VCR may display the text of the command as it is decoded. As an alternative to requiring the user to say “ENTER” or “BACK,” the VCR may display the menu selection for a predetermined interval, for example, two seconds, and then implement the command. During the two-second interval, the user may recall the command, for example, by uttering “BACK.”

In the alternative embodiment, the identified control parameter may trigger a feedback signal from the electronic device 18. The electronic device 18 may transmit the feedback signal to receiver 16 of relay unit 14 or directly to receiver 21 of remote control unit 7. Where the relay unit 14 receives the feedback signal, it may boost the amplitude for transmission to remote control unit 7 or provide an alternative feedback signal such as a telephone conversation. A typical feedback signal is converted by remote control unit into a predetermined audio prompt for output by speaker 29. For example a feedback signal for the command “VCR AUDIO” may be the following menu prompt “SELECT VCR AUDIO MODE . . . STATE 1 FOR MONO . . . STATE 2 FOR STEREO . . . STATE 3 FOR SAP . . . STATE 4 FOR SURROUND SOUND.” The operator may then provide an utterance to select the desired mode of electronic device 18, such as “2”. Or, where the operator wishes to operate a telephone, the operator would speak into the audio input 9 “PHONE ON.” In the exemplary embodiment of the invention, this utterance is then transmitted to relay unit 14 to operate a telephone transceiver (not shown). In this embodiment the feedback signal may be a dial tone or prompt such as “PROVIDE CONTACT NUMBER.” In this way, a user can connect and disconnect a phone communication with predetermined commands such as “PHONE ON” and “PHONE OFF.”

In an alternative embodiment, the menu display on the video display device or the feedback signal may be provided from relay unit 14. In the alternative embodiment, relay unit 14 employs a generic menu, and signals of the remote control unit 7 are translated by the relay unit 14 to correspond to a specific menu interface of an electronic device 18.

The data used to translate the signals provided to relay unit 14 by the remote control 7 into commands usable by the device 18 or to translate signals provided by the device 18 into menu options that may be presented to the remote control 7 may be stored in memory 34, the translation data corresponds to specific manufacturers and models of electronic devices 18. The translation data may be loaded into memory 34 upon manufacture of the relay unit 14, and the remote control 7 may be used to designate which translation data sets are to be employed upon setup of the system 5. When the device 18 is coupled to the relay unit 14 via a bus interface such as IEEE 1394, the translation data may be specified to the relay unit 14 as a part of a “plug and play” operation when power is applied to the device 18 after it is first connected to the bus. Alternatively, the device 18 may download the tables to the relay unit 14 as a part of the plug-and-play operation or in response to a setup command.

Although the exemplary system is described in terms of a hardware implementation, it is contemplated that some or all of the hardware functionality may be practiced entirely in software running on a data processor of a remote control unit. This software may be embodied in a carrier such as magnetic or optical disk or a radio frequency or audio frequency carrier wave.

It will be understood that various changes in the details, materials, and arrangements of the parts which have been described and illustrated above in order to explain the nature of this invention may be made by those skilled in the art without departing from the principle and scope of the invention as recited in the following claims.

What is claimed:

1. A remote control system for translating an utterance of an operator to a control parameter of an electronic device, comprising:
a remote control unit, including,
i. an audio input for receiving the utterance; and
ii. a transmitter operably linked to the audio input for providing a transmission signal corresponding to the utterance;
a relay station responsive to the transmission signal, the relay station including,
i. a receiver for recovering audio signals representing the utterance from the transmission signal;
ii. a speech recognition module for translating the audio signals into a sequence of words;
iii. a memory for translating the sequence of words into the control parameter;
whereby the control parameter is provided to the electronic device enabling hands-free remote control of the electronic device.

2. The remote control system of claim 1, wherein the remote control unit is an operator headset having a microphone coupled to the audio input of the remote control unit.

3. The remote control system of claim 1, wherein the electronic device is operably linked to the relay station to receive the control parameter.

4. The remote control system of claim 1, further comprising:
a display device, coupled to the electronic device for displaying a control menu;
wherein the utterance is translated by the relay unit into a menu navigation control parameter that causes the electronic device to navigate the displayed control menu.

5. The remote control system of claim 4, wherein the navigation of the menu is displayed on the display device in response to the electronic device receiving the menu navigation control parameter.

6. The remote control system of claim 4, wherein the received navigation control parameter is displayed on the display device.

7. The remote control system of claim 1, wherein the relay station further comprises:
a transmitter for providing the control parameter to a remote control input port of the electronic device.

8. The remote control system of claim 7, wherein the remote control unit further comprises:
a receiver for receiving transmissions from the relay station.

9. The remote control system of claim 8, wherein the receiver of the remote control unit is configured to receive menu data from the transmitter of the relay unit and the transmitter of the remote control unit is configured to provide transmission signals representing utterances for selecting a menu option.

10. The remote control system of claim 8, wherein the relay unit further comprises a communications transceiver configured to allow a user to contact a remotely located party, wherein the receiver and transmitter of the remote control unit are configured to receive signals from the communications transceiver and to provide signals to the communications transceiver to utilize the communication transceiver of the relay unit to communicate with the remotely located party.

11. The remote control system of claim 10, wherein the remote control unit and the relay unit are configured to provide voice communication between the remotely located party and the operator.

12. The remote control system of claim 11, wherein the relay unit is operably linked to a telecommunication line and signals corresponding to the voice communication are transferred between the relay unit and the remotely located party over the telecommunication line.

13. A remote control system for translating utterances of an operator to control parameters for a plurality of electronic devices, comprising:
a remote control unit, including,
i. an audio input which receives utterances; and
ii. a transmitter operably linked to the audio input to provide transmission signals corresponding to the utterances;
a relay station responsive to the transmission signals, the relay station including,
i. a receiver which recovers audio signals representing the utterances from the transmission signals;
ii. a speech recognition module which translates the audio signals into words
iii. a memory including a plurality of look-up tables each of which translates the translated words into the control parameters for a respective one of the plurality of devices; and
iv. a processor which selects one of the look-up tables to be used to generate the control parameters responsive to the translated words;
v. a transmitter which provides the control parameters from the selected look-up table to the respective electronic device;
whereby hands-free remote control of the plurality of electronic devices is enabled.

14. A remote control system according to claim 13, wherein:
the memory further comprises a further plurality of look-up tables, each corresponding to a respectively different device type; and
the processor is configured to receive a command to associate one of the further plurality of look-up tables with the plurality of look-up tables to allow use of the one of the further plurality of look-up tables in controlling the corresponding device.

15. A remote control system according to claim 14, wherein the processor is operatively coupled to the corresponding device to receive the command to associate the one of the further plurality of look-up tables with the plurality of look-up tables from the corresponding device.

16. A remote control system for translating an utterance of an operator to a control parameter of an electronic device, comprising:
a remote control unit, including,
i. a microphone for receiving the utterance;
ii. an audio transducer for providing audio information to the operator;
iii. a transmitter operably linked to the microphone for providing a transmission signal corresponding to the utterance;
iv. a receiver responsive to feedback signals and operably linked to the audio transducer for providing audio prompts to the operator
a relay station responsive to the transmission signal, the relay station including,
i. a receiver for recovering the utterance from the transmission signal and for receiving feedback signals from the electronic device,
ii. a speech recognition module for translating the utterance of the operator into the control parameter;
iii. means for transmitting the control parameter to the electronic device, and for transmitting the feedback signal to the receiver of the remote control unit; and
whereby the control parameter is provided to an electronic device and the electronic device provides the feedback signals for prompting an operator of the remote control unit to select one of a plurality of menu options, enabling hands-free remote control of the electronic device.

17. A method of translating an utterance of an operator to a control parameter of an electronic device, comprising:
converting an utterance into a modulated transmission signal;
receiving the transmission signal at a relay unit;
recovering audio signals representing the utterance from the modulated transmission signal;
processing the audio signals to recognize the words included in the utterance; and
translating the recognized words into the control parameter,
providing the control parameter to the electronic device enabling hands-free remote control of the electronic device.

18. A method of translating an utterance of an operator to a control parameter and receiving a feedback signal from the electronic device in response to the control parameter for prompting the operator of the remote control system to select from a plurality of available control parameters, comprising:
converting an utterance into a modulated transmission signal;
receiving the transmission signal at a relay unit;
recovering audio signals representing the utterance from the modulated transmission signal;
processing the audio signals to recognize words included in the utterance;
translating the recognized words into a control parameter for the electronic device;
transmitting the control parameter from the relay unit to the electronic device;
receiving a feedback signal from the electronic device at the relay unit;
designating an utterance menu command corresponding to the feedback signal;
transmitting a signal representing the utterance menu from the relay unit to the remote control unit; and
providing the signal representing the utterance menu as an audio output signal of the remote control unit,
whereby the utterance menu prompts the operator of the remote control unit to select one of a plurality of menu options for the electronic device.
